(19) United States
(12) Patent Application Publication
(10) Pub. No.: US 2025/0189790 A1
(43) Pub. Date: Jun. 12, 2025

(54) HEAD-UP DISPLAY DEVICE

(71) Applicant: Yazaki Corporation, Tokyo (JP)

(72) Inventors: Naohisa MURATA, Shizuoka (JP); Tomohiro MIYAZAWA, Shizuoka (JP)

(73) Assignee: Yazaki Corporation, Tokyo (JP)

(21) Appl. No.: 19/061,041

(22) Filed: Feb. 24, 2025

Related U.S. Application Data
(63) Continuation of application No. PCT/JP2023/035225, filed on Sep. 27, 2023.

(30) Foreign Application Priority Data
Sep. 29, 2022 (JP) 2022-155993

(51) Int. Cl. G02B 27/01

(52) U.S. Cl. CPC G02B 27/0101

(57) ABSTRACT

A head-up display device includes a housing and a display unit. The housing has an opening facing a window shield, and the display unit is assembled therein. The display unit includes a display, a reflection mirror, and a transparent cover. The display is accommodated in the housing and emits display light. The reflection mirror is accommodated in the housing, and reflects enlarged display light obtained by enlarging the display light emitted from the display toward the window shield through the opening. The transparent cover is a cover that closes the opening and transmits light, and includes a free-form face that performs aberration correction on the enlarged display light reflected by the reflection mirror.

### CROSS-REFERENCE TO RELATED APPLICATION

This application is a continuation application of International Application No. PCT/JP2023/035225 filed on Sep. 27, 2023 which claims the benefit of priority from Japanese Patent Application No. 2022-155993 filed on Sep. 29, 2022 and designating the U.S., the entire contents of which are incorporated herein by reference.

### BACKGROUND OF THE INVENTION

### 1. Field of the Invention

The present invention relates to a head-up display device.

### 2. Description of the Related Art

Conventionally, as a head-up display device, for example, Japanese Patent Application Laid-open No. 2006-91104 describes a vehicle head-up display that displays a virtual image via a front window shield of a vehicle. The vehicle head-up display includes a housing that is disposed at an instrument panel of a vehicle and has an opening through which image light of an image is emitted, a display that is housed in the housing and emits the image light of the image, a magnifying glass that is housed in the housing and magnifies and reflects an image directly incident from the display, and a lens that closes the opening of the housing and magnifies the image incident from the magnifying glass to output the image to a front window shield.

In the vehicle head-up display described in Japanese Patent Application Laid-open No. 2006-91104 described above, for example, when a larger virtual image is displayed, it is difficult to correct aberration of the virtual image only with a magnifying glass, and there is room for further improvement in this respect.

### SUMMARY OF THE INVENTION

The present invention has been made in view of the above, and an object of the present invention is to provide a head-up display device capable of appropriately displaying a virtual image.

In order to achieve the above mentioned object, a head-up display device according to one aspect of the present invention includes: a display unit that is provided in a vehicle and displays a virtual image by reflecting display light emitted toward a light transmissive reflecting member toward an eye point by the reflecting member; and a housing that has an opening facing the reflecting member and in which the display unit is assembled, wherein the display unit includes a display that is accommodated in the housing and emits the display light, a reflection mirror that is accommodated in the housing and reflects enlarged display light obtained by enlarging the display light emitted from the display toward the reflecting member through the opening, and a transparent cover that closes the opening and transmits light, the transparent cover having a free-form face that performs aberration correction on the enlarged display light reflected by the reflection mirror.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of a head-up display device according to an embodiment; and

FIG. 2 is a perspective view illustrating a configuration example of a transparent cover according to the embodiment.

### DETAILED DESCRIPTION OF THE PREFERRED EMBODIMENTS

A mode (embodiment) for carrying out the present invention will be described in detail with reference to the drawings. The present invention is not limited by the content described in the following embodiment. In addition, the constituent elements described below include those that can be easily assumed by those skilled in the art and those that are substantially the same. Furthermore, the configurations described below can be appropriately combined. In addition, various omissions, substitutions, or changes in the configuration can be made without departing from the gist of the present invention.

### EMBODIMENTS

A head-up display device 1 according to an embodiment will be described with reference to the drawings. The head-up display device 1 is provided in a vehicle, and displays a virtual image S by reflecting display light L1 emitted toward a window shield WS capable of transmitting light toward the eye point EP by the window shield WS. Here, the window shield WS is an example of a reflecting member, is a member formed of transparent glass in a plate shape, is provided in front of the driver's seat, and blocks wind. The head-up display device 1 may be an AR-HUD device that superimposes and displays the virtual image S on an object in front of the vehicle (for example, a person, a sign, another vehicle, or the like), or may be an HUD device that displays the virtual image S without superimposing the virtual image S on the object in front of the vehicle. Hereinafter, the head-up display device 1 will be described in detail.

Here, a direction along the vehicle width direction of the vehicle is referred to as a first direction X, a direction along the entire length direction of the vehicle is referred to as a second direction Y, and a direction along the vertical direction of the vehicle is referred to as a third direction Z. The second direction Y can also be said to be a direction along a straight traveling direction in which the vehicle travels straight. The third direction Z can also be said to be a direction along the vertical direction. The first direction X, the second direction Y, and the third direction Z intersect each other, and are typically orthogonal to each other. The first direction X and the second direction Y can also be said to be directions along a horizontal plane orthogonal to the vertical direction.

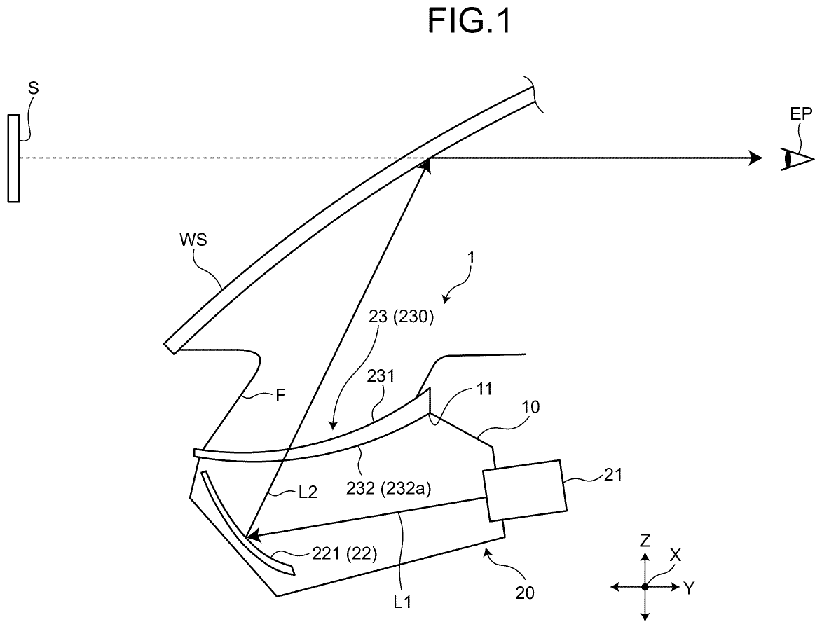

As illustrated in FIG. 1, the head-up display device 1 includes a housing 10 and a display unit 20.

The housing 10 is provided in a vehicle, and the display unit 20 is assembled therein. The housing 10 is formed in a box shape, and accommodates a display 21 and a reflection mirror 22 of the display unit 20 described later inside the housing 10. The housing 10 has an opening 11 that allows the inside and the outside to communicate with each other. The opening 11 is a site that is provided to face the window shield WS and is capable of transmitting light.

The display unit 20 displays the virtual image S by reflecting the display light L1 emitted toward the window shield WS toward the eye point EP by the window shield WS. The display unit 20 includes the display 21, the reflection mirror 22, and a transparent cover 23.

The display 21 emits the display light L1 including an image, and is accommodated in the housing 10. The display 21 includes, for example, a display and a backlight. The display forms an image, and includes, for example, a thin film transistor-liquid crystal display (TFT-LCD) or the like. The backlight irradiates the back face of the display with light, and includes, for example, a plurality of light-emitting diodes (LEDs). The display 21 emits the display light L1 including an image from the display toward the reflection mirror 22 by irradiating the display with light by the backlight. For example, the display 21 directly emits the display light L1 to the reflection mirror 22 without via another mirror. That is, no optical component is interposed between the display 21 and the reflection mirror 22.

Note that, in this example, in the display 21, part of the display 21 is accommodated inside the housing 10, and the other part of the display 21 is exposed to the outside of the housing 10. Specifically, in the display 21, an emission unit (for example, a display) that emits the display light L1 is accommodated in the housing 10, and a portion (for example, backlight) other than the emission unit of the display 21 is exposed to the outside of the housing 10.

The reflection mirror 22 totally reflects light and is accommodated in the housing 10. The reflection mirror 22 has a reflection face 221 formed in a concave shape and an aspherical shape. The reflection face 221 is disposed to face the display 21 and is disposed to face the transparent cover 23. The reflection mirror 22 enlarges the display light L1 (image) emitted from the display 21 by the reflection face 221, and reflects the enlarged display light L2 toward the window shield WS through the opening 11 (transparent cover 23) of the housing 10. Specifically, the reflection mirror 22 enlarges the display light L1 directly emitted from the display 21 without via another mirror by the reflection face 221, and reflects the enlarged display light L2 toward the window shield WS through the opening 11 (transparent cover 23) of the housing 10.

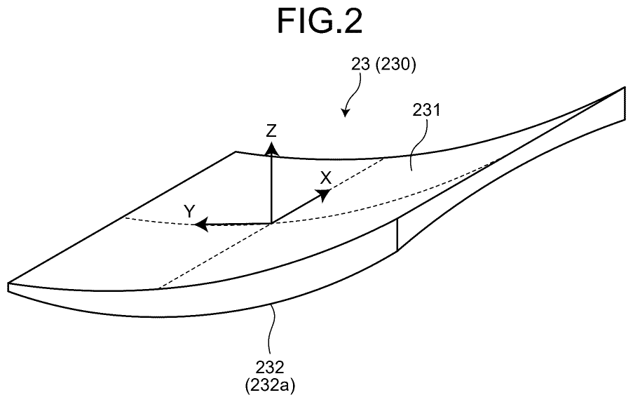

The transparent cover 23 is a cover that closes the opening 11 of the housing 10 and transmits light. Transparent cover 23 is formed of a transparent resin in a curved plate shape, and closes the opening 11. The transparent cover 23 has a curved portion 230 formed in a curved shape toward the inside of a housing 2. That is, the curved portion 230 is formed in a concave shape toward the inside of the housing 2. As illustrated in FIG. 2, the curved portion 230 has an outer face part 231 as a second face part and an inner face part 232 as a first face part.

The outer face part 231 is a face part that is located away from the reflection mirror 22 and is formed to be curved toward the inside of the housing 2. That is, the outer face part 231 is a face part provided close to the window shield WS. The outer face part 231 reflects external light toward a facing portion F. Here, the facing portion F shields light, and is erected opposite the eye point EP with respect to the opening 11. That is, the facing portion F is a wall portion provided to extend along the third direction Z, the wall portion being opposite the eye point EP with respect to the transparent cover 23. In this example, the facing portion F is provided slightly inclined toward the transparent cover 23. The outer face part 231 is formed in a shape that reflects external light incident from the outside of the housing 2 toward the facing portion F. Specifically, the XZ cross section cut along the first direction X and the third direction Z of the outer face part 231 is formed linearly without being curved. The YZ cross section cut along the second direction Y and the third direction Z of the outer face part 231 is formed in a curved shape, and is formed in a curved shape with a curvature capable of reflecting external light toward the facing portion F. The outer face part 231 reflects external light incident from the outside of the housing 2 toward the facing portion F.

The inner face part 232 is a face part that is located close to the reflection mirror 22 and is formed to be curved toward the inside of the housing 2. That is, the inner face part 232 is a face part provided away from the window shield WS. The inner face part 232 has a free-form face 232a. The free-form face 232a is a curved face that cannot be expressed by a simple mathematical expression like a sphere or a cylinder. A free-form face 232a is, for example, a curved face in which a plurality of intersections and a plurality of curvatures are set in a space and respective intersections are interpolated by a high-order polynomial. The free-form face 232a is formed in a shape that corrects aberration of the virtual image S generated by the optical member including the window shield WS and the like. The free-form face 232a is formed in a shape that corrects aberration of the virtual image S generated by the shape of the window shield WS, for example. The transparent cover 23 performs aberration correction on the enlarged display light L2 reflected by the reflection mirror 22 by the free-form face 232a. Then, the transparent cover 23 emits the corrected enlarged display light L2 subjected to the aberration correction by the free-form face 232a toward the window shield WS. The corrected enlarged display light L2 emitted toward the window shield WS is reflected toward the eye point EP by the window shield WS and guided to the eye point EP.

As described above, the head-up display device 1 according to the embodiment includes the housing 10 and the display unit 20. The housing 10 has an opening 11 facing the window shield WS, and the display unit 20 is assembled therein. The display unit 20 is provided in the vehicle, and displays the virtual image S by reflecting the display light L1 emitted toward the window shield WS capable of transmitting light toward an eye point EP by the window shield WS. The above-described display unit 20 includes the display 21, the reflection mirror 22, and the transparent cover 23. The display 21 is accommodated in the housing 10 and emits the display light L1. The reflection mirror 22 is accommodated in the housing 10, and reflects the enlarged display light L2 obtained by enlarging the display light L1 emitted from the display 21 toward the window shield WS through the opening 11. The transparent cover 23 is a cover that closes the opening 11 and transmits light, and has the free-form face 232a that performs aberration correction on the enlarged display light L2 reflected by the reflection mirror 22.

With this configuration, the head-up display device 1 can correct the aberration of the virtual image S generated by the optical member including the window shield WS and the like by the free-form face 232a of the transparent cover 23. The head-up display device 1 causes the transparent cover 23 to mainly have the aberration correction function, and causes the reflection mirror 22 to mainly have the enlarging function, so that the accuracy of the aberration correction can be improved and the enlargement ratio can be improved. The head-up display device 1 can be easily manufactured because the parameter coefficients can be reduced by performing the role sharing, whereby the tolerance can be reduced. In the head-up display device 1, the transparent cover 23 that closes the opening 11 of housing 10 also have a function of correcting aberration, so that an increase in the number of components and an increase in size of the optical system can be suppressed. As a result, the head-up display device 1 can appropriately display the virtual image S.

In the head-up display device 1, the display 21 directly emits the display light L1 to the reflection mirror 22. The reflection mirror 22 reflects the enlarged display light L2 obtained by enlarging the display light L1 directly emitted from the display 21 to the window shield WS through the transparent cover 23. With this configuration, in the head-up display device 1, the display 21 directly emits the display light L1 to the reflection mirror 22 without via another mirror, so that the device can be downsized.

In the head-up display device 1, the free-form face 232a is formed at face of the transparent cover 23, the face being close to the reflection mirror 22. With this configuration, the head-up display device 1 can properly reflect the external light toward the facing portion F by the outer face part 231 of the transparent cover 23, the outer face part being away the reflection mirror 22.

Note that, in the above description, an example has been described in which the display 21 directly emits the display light L1 to the reflection mirror 22 without via another mirror, but the present invention is not limited thereto, and the display may indirectly emit the display light L1 to the reflection mirror 22 via another mirror.

The example in which the free-form face 232a is formed at a face of the transparent cover 23, the face being close to the reflection mirror 22, is described, but the free-form face is not limited thereto, and may be formed at a face of the transparent cover 23, the face being away the reflection mirror 22.

The transparent cover 23 may have a function of enlarging the enlarged display light L2 (image) in addition to the function of correcting the aberration of the virtual image S by the free-form face 232a. In this case, the transparent cover 23 enlarges the enlarged display light L2 (image) at an enlargement ratio smaller than the enlargement ratio of the reflection mirror 22. For example, the transparent cover 23 enlarges the enlarged display light L2 (image) at an enlargement ratio of about 1/10 of the enlargement ratio of the reflection mirror 22.

The reflection mirror 22 may have a function of correcting the aberration of the virtual image S in addition to the function of enlarging the display light L1 (image) by the reflection face 221. In this case, the reflection mirror 22 corrects the aberration of the virtual image S with the aberration correction amount smaller than that of transparent cover 23. For example, the reflection mirror 22 corrects the aberration of the virtual image S by the aberration correction amount of about 1/10 of the aberration correction amount of transparent cover 23.

Although the example in which the reflecting member is the window shield WS has been described, the reflecting member is not limited thereto, and may be, for example, a combiner or the like.

The head-up display device according to the present embodiment can correct the aberration of the virtual image caused by the optical member including the reflecting member by the free-form face of the transparent cover. The head-up display device can appropriately perform the aberration correction and the enlargement processing of the virtual image by causing the transparent cover to mainly have the aberration correction function and causing the reflection mirror to mainly have the enlargement function. As a result, the head-up display device can appropriately display the virtual image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head-up display device comprising:
a display unit that is provided in a vehicle and displays a virtual image by reflecting display light emitted toward a light transmissive reflecting member toward an eye point by the reflecting member; and
a housing that has an opening facing the reflecting member and in which the display unit is assembled, wherein
the display unit includes
a display that is accommodated in the housing and emits the display light,
a reflection mirror that is accommodated in the housing and reflects enlarged display light obtained by enlarging the display light emitted from the display toward the reflecting member through the opening, and
a transparent cover that closes the opening and transmits light, the transparent cover having a free-form face that performs aberration correction on the enlarged display light reflected by the reflection mirror, and
the transparent cover has a function of further enlarging the enlarged display light by the free-form face, and enlarges the enlarged display light at an enlargement ratio smaller than the enlargement ratio of the reflection mirror.

2. The head-up display device according to claim 1, wherein
the display directly emits the display light to the reflection mirror, and
the reflection mirror reflects the enlarged display light obtained by enlarging the display light directly emitted from the display to the reflecting member through the transparent cover.

3. The head-up display device according to claim 1, wherein
the free-form face is formed at the reflection mirror side of the transparent cover.

4. The head-up display device according to claim 2, wherein
the free-form face is formed at the reflection mirror side of the transparent cover.
